(19) United States
(12) Patent Application Publication
(10) Pub. No.: US 2022/0118526 A1
(43) Pub. Date: Apr. 21, 2022

(54) Rotary cutting tool and cutting tool parts

(71) Applicant: KENNAMETAL INC., Latrobe, PA (US)

(72) Inventors: Christoph Gey, Stetten (CH); Patrick Kuhlemann, Fuerth (DE); Marcelo Euripedes da Silva, Piracicaba (BR)

(21) Appl. No.: 17/502,471

(22) Filed: Oct. 15, 2021

(30) Foreign Application Priority Data
Oct. 15, 2020 (DE) 102020127229.4

(51) Int. Cl. B23B 27/16

(52) U.S. Cl. CPC B23B 27/16

(57) ABSTRACT

The invention describes a rotary cutting tool, in particular a drill, which comprises a first cutting tool part having at least one cutting edge and a second cutting tool part which comprises a cutting tool shank. The first cutting tool part and the second cutting tool part are releasably connected to one another via a coupling mechanism which comprises a coupling cam that is mounted on one of the two cutting tool parts such that it can rotate about an axis of rotation and, in a coupling position, abuts an engagement surface on the other cutting tool part. The invention also presents a cutting tool part, in particular a cutting tool base, and a further cutting tool part, in particular a cutting tip.

### RELATED APPLICATION DATA

The present invention claims priority pursuant to 35 U.S.C. § 119(a) to German Patent Application Number 102020127229.4 filed Oct. 15, 2020 which is incorporated herein by reference in its entirety.

### FIELD

The invention relates to a rotary cutting tool, in particular a drill, comprising a first cutting tool part on which at least one cutting edge is disposed and a second cutting tool part which comprises a cutting tool shank. The first cutting tool part and the second cutting tool part are adjacent to one another along an axis of rotation of the rotary cutting tool and are releasably connected to one another via a coupling mechanism.

The invention is also directed to a cutting tool part, in particular a cutting tool base, for such a rotary cutting tool which comprises a coupling interface for coupling the cutting tool part to another cutting tool part. Such a cutting tool part is sometimes also referred to as a cutting tool shank, which, in view of the fact that it does not only include the cutting tool shank, is overly simplified.

The invention is also directed to a further cutting tool part, in particular a cutting tip, for such a rotary cutting tool which comprises a coupling interface for coupling the cutting tool part to another cutting tool part.

### BACKGROUND

Such rotary cutting tools and cutting tool parts provided for them are known from the state of the art.

Due to the fact that the cutting tool part on which the at least one cutting edge is disposed can be removed from the cutting tool part that comprises the cutting tool shank, such rotary cutting tools are also referred to as rotary cutting tools having exchangeable cutting tips or, more generally, as modular rotary cutting tools.

Overall, the objective is to provide a rotary cutting tool in which the cutting tool parts that are subject to wear during operation can easily be replaced so that the rotary cutting tool can be used for a long period of time. A side effect of this design is that a suitable material can be used for each cutting tool part. It is thus in particular possible to use comparatively hard materials having good cutting properties for the cutting tool part on which the cutting edge is disposed. Less hard but more elastic materials can be used for the cutting tool part comprising the cutting tool shank.

In rotary cutting tools of the abovementioned type, it is important that the two cutting tool parts forming the rotary cutting tool are held together reliably. It is in particular necessary to prevent the cutting tool parts from separating from one another during operation of the rotary cutting tool under the influence of elastic or plastic deformations that can occur during an associated cutting process.

At the same time, however, it should also be possible to separate the two cutting tool parts from one another quickly and easily. The assembly of the cutting tool parts to form the rotary cutting tool should likewise be quick and easy to carry out.

There is obviously some conflict of objectives between ease of assembly and disassembly and firmly holding the parts together.

### SUMMARY

The object of the invention is therefore to further improve known rotary cutting tools. The intent is in particular to specify a rotary cutting tool, the cutting tool parts of which can be held together particularly reliably and firmly. At the same time, the cutting tool parts should be able to be easily separated from one another and easily connected to one another.

The object is achieved by a rotary cutting tool of the abovementioned type, in which the coupling mechanism comprises a coupling cam that is mounted on one of the two cutting tool parts such that it can rotate about an axis of rotation and, in a coupling position, abuts an engagement surface on the other cutting tool part, so that the first cutting tool part and the second cutting tool part are coupled in the direction of the axis of rotation. The first cutting tool part and the second cutting tool part are thus secured to one another, in particular along a pull-out direction. In the present case, a cam is understood to be a rotatably mounted component that is also provided with a certain eccentricity. When the coupling cam is in the coupling position and abuts the engagement surface, the first cutting tool part and the second cutting tool part are reliably coupled to one another via a form-fitting connection and/or a frictional connection. By means of the coupling cam, it is in particular possible to place the first cutting tool part and the second cutting tool part against one another with a certain amount of pretension along the axis of rotation. This results in a particularly reliable coupling of the two cutting tool parts. Such a coupling can be established quickly and easily by rotating the coupling cam. Such a coupling can also be released again quickly and easily by rotating the coupling cam in an opposite direction. In other words, the cutting tool parts forming such a rotary cutting tool can be coupled and uncoupled quickly and easily.

To ensure that the two cutting tool parts are precisely positioned relative to one another along the axis of rotation in the coupled state, at least one axially aligned abutment surface can be provided on one of the cutting tool parts which, in the coupled state, abuts an axially aligned counter-abutment surface of the other cutting tool part. The axially aligned abutment surface and the axially aligned counter-abutment surface are in particular separate from the coupling mechanism.

A centering surface can also be provided on one of the cutting tool parts, which, in the coupled state, abuts a centering counter surface of the other cutting tool part. The two cutting tool parts can thus be reliably centered with respect to the axis of rotation. The centering mechanism is also in particular independent of the coupling mechanism.

When the rotary cutting tool is in operation, the cutting tool part comprising the cutting tool shank is typically coupled to a machine and driven in rotation. In order to be able to transmit a torque from this cutting tool part to the cutting tool part on which the cutting edge is disposed, a driver geometry can be provided on one of the cutting tool parts, which interacts with an associated counter geometry on the other cutting tool part. The driver geometry and the associated counter geometry are likewise in particular separate from the coupling mechanism.

According to one embodiment, in the coupling position of the coupling cam, the first cutting tool part and the second cutting tool part are coupled in a form-locking manner in the direction of the axis of rotation. This results in a particularly reliable coupling of the two cutting tool parts.

The axis of rotation of the coupling cam can extend transverse, in particular perpendicular, to the axis of rotation of the rotary cutting tool. The axis of rotation therefore extends radially or diametrically with respect to the axis of rotation of the rotary cutting tool. An influence of a rotation of the rotary cutting tool about its axis of rotation on the coupling mechanism is thus kept to a minimum or eliminated. In other words, influences from the operation of the rotary cutting tool on the coupling mechanism are low or non-existent. This too results in a more reliable fastening of the two cutting tool parts to one another.

According to one variant, the coupling cam is substantially elliptical or parabolic in a cross-section oriented substantially perpendicular to the axis of rotation. In this context, a parabolic cross-section is to be understood to be a cross-section, the edge of which is at least partly parabolic. A parabolic cross-section can be composed of two parabolas, for example, in such a way that the vertices of the parabolas face away from one another. Therefore, as already mentioned, the coupling cam is eccentric in cross-section with respect to the axis of rotation. The two cutting tool parts can thus easily be connected to one another by rotating the coupling cam about the axis of rotation. The cutting tool parts can be separated from one another by rotating the coupling cam in an opposite direction about the axis of rotation. Also, by means of the elliptical or parabolic coupling cam, a pretension under which the two cutting tool parts are placed against one another can be adjusted substantially continuously and sensitively by rotating the coupling cam.

The coupling cam is advantageously disposed in an end portion of the first cutting tool part or the second cutting tool part facing the respective other cutting tool part. The coupling cam is therefore always positioned in the region of a connection point between the two cutting tool parts. Forces required to couple the cutting tool parts are consequently introduced comparatively directly into the coupling mechanism. This results in a reliable coupling. This also results in a simple structure of the rotary cutting tool. Moreover, a region of the rotary cutting tool in which the connection point is disposed is typically easily accessible. This is true in particular when the rotary cutting tool is clamped into an associated machine. This facilitates the coupling and uncoupling of the cutting tool parts.

The coupling cam can be seated on a camshaft that is mounted within the first cutting tool part or the second cutting tool part such that it can rotate about the axis of rotation. A tool engagement contour is in particular provided on at least one end of the camshaft. The camshaft and with it the coupling cam can thus be rotated by means of a tool that engages with the tool engagement contour. As already mentioned, via such a rotation, a coupling or uncoupling of the cutting tool parts can be effected in a simple manner. In other words, the camshaft and associated coupling cam can assume a coupling position in which the two cutting tool parts are connected to one another, or an assembly position in which the two cutting tool parts can be moved relative to one another. It goes without saying that the tool engagement contour has to be accessible from the outside of the cutting tool so that it can interact with a tool. The tool engagement contour is in particular accessible in a radial direction of the rotary cutting tool.

The coupling cam can be produced in one piece with the camshaft or integrally connected to the camshaft. Both cases result in a reliable holding together of the coupling cam and the camshaft, which also results in a reliable coupling of the two cutting tool parts. Such components can furthermore be produced simply and inexpensively.

End-side bearing portions can be provided on the camshaft for rotatably mounting the camshaft in the associated cutting tool part. The end-side bearing portions are in particular rotationally symmetric with respect to the axis of rotation. Moreover, in particular in the case that the coupling cam and camshaft are produced in one piece, a diameter of the bearing portions can be selected such that its size is at least equal to the largest diameter of the coupling cam. This ensures that the composite consisting of the coupling cam and the camshaft can easily be mounted on the associated cutting tool part. This composite is advantageously inserted in radial direction into an associated receiving space of the associated cutting tool part.

In one variant, the engagement surface forms an undercut which acts in the direction of the axis of rotation of the rotary cutting tool and in a separating direction of the cutting tool parts. The separating direction refers to a direction oriented along the axis of rotation in which the two cutting tool parts are moved away from one another. The undercut allows the cutting tool parts to be fastened to one another in a reliable manner.

According to one embodiment, it is provided that the engagement surface comprises a cylinder jacket surface portion, in particular a circular cylinder jacket surface portion or a jacket surface portion of a cylinder having an elliptical bottom surface. On the one hand, such an engagement surface can easily be produced using standard production methods and machines. On the other hand, in cooperation with the coupling cam which is in particular elliptical in cross-section, such an engagement surface is a way of precisely and reliably setting a pretensioning force or holding force by means of which the two cutting tool parts are held together by varying the degree of rotation of the coupling cam relative to the engagement surface.

In one variant, a central axis associated with the cylinder jacket portion extends transverse, preferably perpendicular, to the axis of rotation of the rotary cutting tool. The central axis in particular extends substantially parallel to the axis of rotation of the coupling cam. This results in a compact structure of the rotary cutting tool. It also ensures that the coupling cam abuts the engagement surface with a line contact or a surface contact. This leads to a reliable coupling of the cutting tool parts.

The engagement surface can be configured as a section of a coupling groove, wherein the coupling groove is provided on the first cutting tool part or on the second cutting tool part and an opening of the coupling groove faces in the direction of the respective other cutting tool part. The opening direction of the coupling groove thus corresponds substantially to the axis of rotation. This allows the cutting tool parts to be coupled to one another and uncoupled from one another quickly and easily. Such a structure furthermore saves space.

If the engagement surface forms an undercut, said undercut acts in a depth direction of the coupling groove.

The engagement surface is in particular disposed in the region of a groove base of the coupling groove. The engagement surface can then at least form portions of the groove base. The remaining portions of the coupling groove, in particular the portions facing toward the opening, can therefore be used to align the two cutting tool parts with one another before the coupling cam is positioned in the region of the groove base, i.e. in the region of the engagement surface. The coupling of the cutting tool parts is thus facilitated.

The coupling cam and the coupling groove can be matched to one another such that, in an assembly position, the coupling cam can be slid along the axis of rotation of the rotary cutting tool inside the coupling groove. In this context, the largest diameter of the coupling cam is in particular oriented in a depth direction of the coupling groove. The coupling cam can thus easily be inserted into or moved out of the coupling groove. When the coupling cam reaches the region of the groove base, it can be rotated such that its maximum diameter is no longer oriented in the depth direction of the coupling groove. This can result in a form-fitting connection and/or a force-fitting connection, so that the two cutting tool parts are reliably coupled to one another.

The object is further achieved by a cutting tool part, in particular a cutting tool base, for a rotary cutting tool according to the invention. The cutting tool part comprises a coupling interface for coupling the cutting tool part to another cutting tool part, wherein the coupling interface comprises a rotatably mounted coupling cam. For such a cutting tool part, the effects and advantages already mentioned with respect to the rotary cutting tool in connection with a coupling cam result. Such a cutting tool part can thus easily be coupled to another cutting tool part, whereby the coupling is particularly reliable.

The object is also achieved by a cutting tool part, in particular a cutting tip, for a rotary cutting tool according to the invention. The cutting tool part comprises a coupling interface for coupling the cutting tool part to another cutting tool part, wherein the coupling interface comprises an engagement surface for a coupling cam. In this context, too, the effects and advantages for such a cutting tool part result as already discussed in connection with the rotary cutting tool and an engagement surface for the coupling cam. Such a cutting tool part can thus likewise easily be coupled to another cutting tool part, whereby the coupling is particularly reliable.

### DETAILED DESCRIPTION

The invention is explained below with the aid of a design example, which is shown in the accompanying drawings. The figures show:

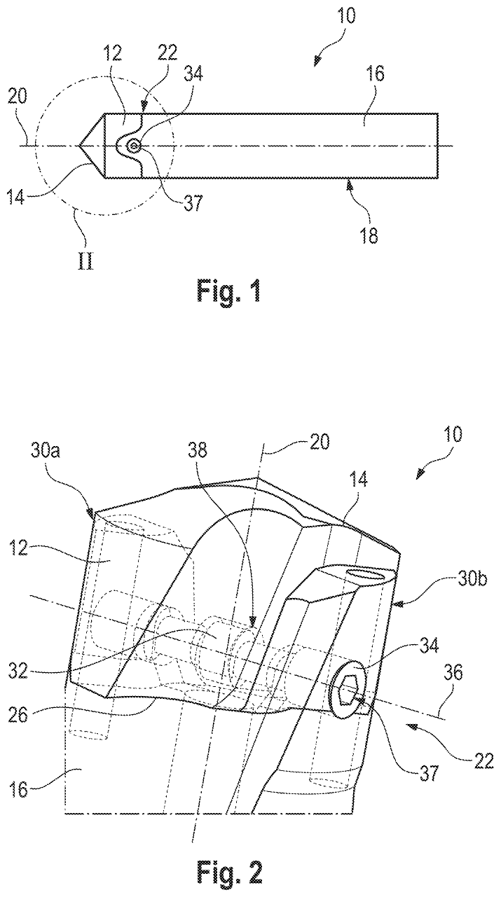

FIG. 1 in a schematic side view, a rotary cutting tool according to the invention composed of two cutting tool parts according to the invention,

FIG. 2 a detail II of the rotary cutting tool of FIG. 1 in a perspective view,

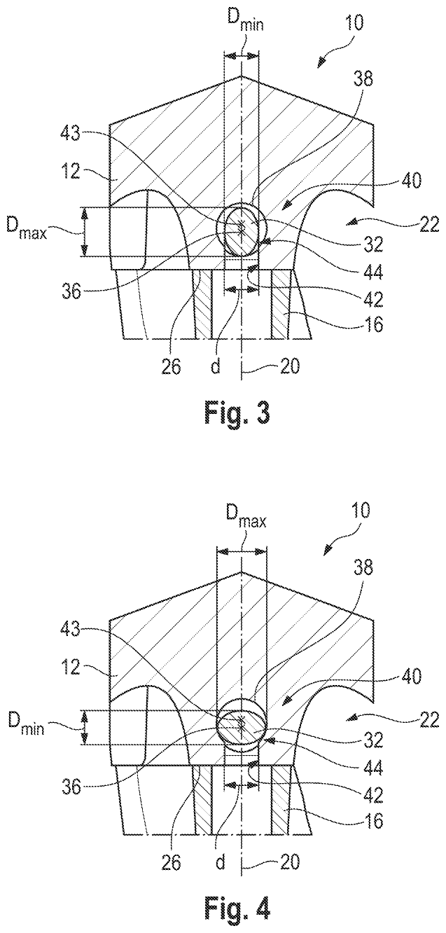

FIG. 3 a diametric section through the portion of the rotary cutting tool shown in FIG. 2, wherein a coupling cam is in an assembly position,

FIG. 4 a sectional view corresponding to FIG. 3, wherein the coupling cam is in a coupling position,

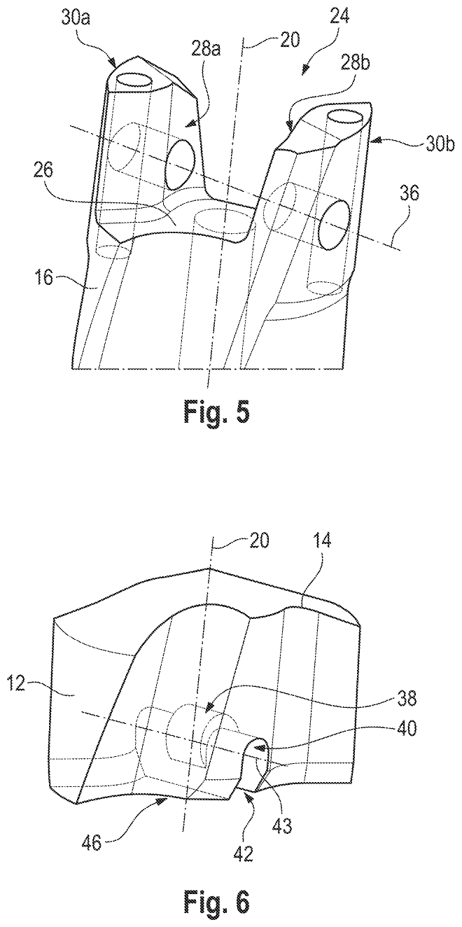

FIG. 5 a portion of one of the cutting tool parts according to the invention of the rotary cutting tool of FIG. 1 comprising a coupling interface,

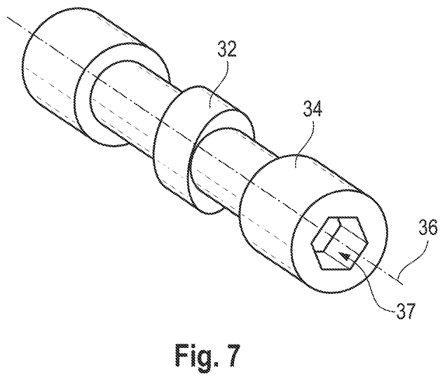

FIG. 6 the other cutting tool part according to the invention of the rotary cutting tool of FIG. 1, and

FIG. 7 a composite consisting of a coupling cam and a camshaft of the rotary cutting tool of FIG. 1 in an isolated illustration.

FIG. 1 shows a rotary cutting tool 10 which, in the embodiment shown, is a drill.

The rotary cutting tool 10 comprises a first cutting tool part 12 on which a cutting edge 14 is disposed. The first cutting tool part 12 can therefore also be referred to as the cutting tip.

The rotary cutting tool 10 also comprises a second cutting tool part 16 which comprises a cutting tool shank 18. In simplified form, the second cutting tool part 16 can therefore be referred to as a cutting tool base or cutting tool shank.

The first cutting tool part 12 and the second cutting tool part 16 are disposed adjacent one another along an axis of rotation 20 of the rotary cutting tool 10 and releasably connected to one another via a coupling mechanism 22.

The coupling mechanism 22 is discussed in more detail below with reference to FIGS. 2 to 7.

In this regard, the second cutting tool part 16 comprises a coupling interface 24 for coupling with the first cutting tool part 12 (see in particular the isolated illustration in FIG. 5).

The coupling interface 24 comprises an axially oriented abutment surface 26 against which the first cutting tool part 12 can be placed along the axis of rotation 20. The coupling interface 24 also comprises two centering surfaces 28a, 28b by means of which the first cutting tool part 12 can be centered on the second cutting tool part 16.

The centering surfaces 28a, 28b are configured as radial inner surfaces of two driver fingers 30a, 30b.

The driver fingers 30a, 30b also serve to introduce a torque, starting from the second cutting tool part 16, into the first cutting tool part 12, which of course carries the cutting edge 14.

For coupling the two cutting tool parts 12, 16, the coupling interface 24 also comprises a rotatably mounted coupling cam 32 (see in particular FIGS. 2 and 7).

In the present case, the coupling cam 32 is produced in one piece with a camshaft 34.

The composite consisting of the camshaft 34 and the coupling cam 32 is mounted in the second cutting tool part 16 such that it can rotate about an axis of rotation 36.

A tool engagement contour 37 is also provided at one end of the camshaft 34, so that the camshaft 34 can be rotated together with the coupling cam 32 by means of a tool.

As is evident in particular from the illustration of FIG. 2, the coupling cam 32 is mounted together with the camshaft 34 in an end portion of the second cutting tool part 16 which faces the first cutting tool part 12.

The coupling cam 32 is furthermore elliptical in a cross-section oriented substantially perpendicular to the axis of rotation 36 (see FIGS. 3 and 4).

The axis of rotation 36 of the coupling cam 32 extends substantially perpendicular to the axis of rotation 20 of the rotary cutting tool 10 (see FIGS. 3 to 5).

The coupling mechanism 22 also comprises an engagement surface 38, which is disposed in the region of a groove base 40 of a coupling groove 42.

The coupling groove 42 is configured on the first cutting tool part 12 and extends substantially diametrically with respect to the axis of rotation 20 (see FIGS. 3, 4 and 6).

The coupling groove 42 is furthermore open in the direction of the second cutting tool part 16.

The engagement surface 38 is configured as a circular cylinder jacket surface portion, the associated central axis 43 of which, on the one hand, extends perpendicular to the axis of rotation 20 of the rotary cutting tool 10 and, on the other hand, is aligned substantially parallel to the axis of rotation 36 of the coupling cam 32 (see FIGS. 3 and 4).

The engagement surface 38 also forms an undercut 44 which acts in the direction of the axis of rotation 20 of the rotary cutting tool 10.

The coupling groove 42 with the engagement surface 38 thus forms a coupling interface 46 of the first cutting tool part 12 for coupling with the second cutting tool part 16.

The coupling cam 32 can assume two specific positions when it interacts with the engagement surface 38.

In an assembly position, which can in particular be seen in FIG. 3, a largest diameter Dₘₐₓ of the coupling cam 32 is oriented along the axis of rotation 20.

Consequently, the largest diameter Dₘₐₓ of the coupling cam 32 is also oriented along a depth direction of the coupling groove 42.

The coupling cam 32 and the coupling groove are matched to one another such that, in this assembly position, the coupling cam 32 can be slid along the depth direction inside the coupling groove 42.

In other words, a groove width d is at least slightly larger than a smallest diameter Dₘᵢₙ of the coupling cam which is then oriented transverse to the axis of rotation 20 and transverse to the depth direction of the coupling groove 42.

Now, when the first cutting tool part 12 is aligned along the axis of rotation 20 relative to the second cutting tool part 16 such that it abuts the axial abutment surface 26, the coupling cam 32 is located in the region of the groove base 40 of the coupling groove 42. It can now be rotated about the axis of rotation 36 so that it assumes a coupling position in which it abuts the engagement surface 38 (see FIG. 4).

Since the largest diameter Dₘₐₓ of the coupling cam 32 is now no longer oriented along the axis of rotation 20 but transversely to it, said coupling cam engages behind the undercut 44.

As a result, the two cutting tool parts 12, 16 are coupled to one another in a form-locking manner.

This form-locking coupling exists in particular along the axis of rotation 20 and in a direction in which the two cutting tool parts 12, 16 are separated from one another, i.e. removed from one another.

1. A rotary cutting tool comprising:
a first cutting tool part on which at least one cutting edge is disposed and a second cutting tool part which comprises a cutting tool shank,
wherein the first cutting tool part and the second cutting tool part are adjacent to one another along an axis of rotation of the rotary cutting tool and are releasably connected to one another via a coupling mechanism,
wherein the coupling mechanism comprises a coupling cam that is mounted on one of the two cutting tool parts such that it can rotate about an axis of rotation and, in a coupling position, abuts an engagement surface on the other cutting tool part, so that the first cutting tool part and the second cutting tool part are coupled in the direction of the axis of rotation.

2. The rotary cutting tool according to claim 1, wherein, in the coupling position of the coupling cam, the first cutting tool part and the second cutting tool part are coupled in a form-locking manner in the direction of the axis of rotation.

3. The rotary cutting tool according to claim 1, wherein the axis of rotation of the coupling cam extends transverse to the axis of rotation of the rotary cutting tool.

4. The rotary cutting tool according to claim 1, wherein the coupling cam is substantially elliptical or parabolic in a cross-section oriented substantially perpendicular to the axis of rotation.

5. The rotary cutting tool according to claim 1, wherein the coupling cam is disposed in an end portion of the first cutting tool part or the second cutting tool part facing the respective other cutting tool part.

6. The rotary cutting tool according to claim 1, wherein the coupling cam is seated on a camshaft that is mounted within the first cutting tool part or the second cutting tool part such that it can rotate about the axis of rotation.

7. The rotary cutting tool according to claim 6, wherein the coupling cam is produced in one piece with the camshaft or is integrally connected to the camshaft.

8. The rotary cutting tool according to claim 1, wherein the engagement surface forms an undercut which acts in the direction of the axis of rotation of the rotary cutting tool and in a separating direction of the cutting tool parts.

9. The rotary cutting tool according to claim 1, wherein the engagement surface comprises a cylinder jacket surface portion.

10. The rotary cutting tool according to claim 9, wherein a central axis associated with the cylinder jacket surface portion extends transverse to the axis of rotation of the rotary cutting tool.

11. The rotary cutting tool of claim 1, wherein the engagement surface is configured as a section of a coupling groove, wherein the coupling groove is provided on the first cutting tool part or on the second cutting tool part and an opening of the coupling groove faces in the direction of the respective other cutting tool part.

12. The rotary cutting tool according to claim 11, wherein the engagement surface is disposed in the region of a groove base of the coupling groove.

13. The rotary cutting tool according to claim 11, wherein the coupling cam and the coupling groove are matched to one another such that, in an assembly position, the coupling cam can be slid along the axis of rotation of the rotary cutting tool inside the coupling groove.

14. A cutting tool part for a rotary cutting tool according to claim 1 comprising a coupling interface for coupling the cutting tool part to another cutting tool part, wherein the coupling interface comprises a rotatably mounted coupling cam.

15. A cutting tool part for a rotary cutting tool according to claim 1 comprising a coupling interface for coupling the cutting tool part to another cutting tool part, wherein the coupling interface comprises an engagement surface for a coupling cam.

16. The rotary cutting tool according to claim 1, wherein the rotary cutting tool is a drill.

17. The rotary cutting tool according to claim 3, wherein the axis of rotation of the coupling cam extends normal to the axis of rotation of the rotary cutting tool.

18. The rotary cutting tool according to claim 6, wherein a tool engagement contour is provided on at least one end of the camshaft.

19. The rotary cutting tool according to claim 9, wherein the cylinder jacket portion is a circular cylinder jacket surface portion or a jacket surface portion of a cylinder having an elliptical bottom surface.

20. The rotary cutting tool of claim 10, wherein the central axis extends substantially parallel to the axis of rotation of the coupling cam.
